(19) United States
(12) Patent Application Publication
(10) Pub. No.: US 2018/0322458 A1
(43) Pub. Date: Nov. 8, 2018

(54) System and Methods for Prime-Subcontractor Teaming

(71) Applicant: Joanne Michele Frederick, Baltimore, MD (US)

(72) Inventor: Joanne Michele Frederick, Baltimore, MD (US)

(21) Appl. No.: 15/970,388

(22) Filed: May 3, 2018

Related U.S. Application Data
(60) Provisional application No. 62/501,381, filed on May 4, 2017.

(51) Int. Cl. G06Q 10/10; G06Q 30/08; G06Q 10/06

(52) U.S. Cl. CPC G06Q 10/101; G06Q 10/0631; G06Q 30/08

(57) ABSTRACT

A system and methods for prime-subcontractor teaming are disclosed. The system includes a vendor interface, a solicitation document interface and a teaming analyzer. Vendor data and solicitation document data are captured and associated with a common government agency coding system. Using a code-based framework, the vendor data and solicitation document data are compared and analyzed for a vendor's competitive position in submitting a bid on a solicitation document. Suggested vendor teaming may improve a vendor's competitive position. Results of submitted bids are captured to improve competitive position analysis and future bid success.

### CROSS-REFERENCE TO RELATED APPLICATION

This application claims the benefit of U.S. Provisional Application No. 62/501,381, filed on May 4, 2017.

### BACKGROUND OF THE INVENTION

The Federal Government has in excess of a trillion dollar budget for discretionary spending on government contracts. As mandated by the 15 U.S. Code § 644, the Federal Government must give meaningful opportunity to small businesses to do business with the government. The Small Business Act of 1953 created the Small Business Administration (SBA). In the intervening years, the SBA has grown and additional laws and regulations better define the Federal Government requirements for small businesses. The Federal Acquisition Regulation (FAR) Part 19 implements the acquisition-related sections of the Small Business Act (15 U.S.C. 631, et seq.), applicable sections of the Armed Services Procurement Act (10 U.S.C. 2302, et seq.), 41 U.S.C. 3104, and Executive Order 12138, May 18, 1979. FAR Subpart 19.7—The Small Business Subcontracting Program—outlines the requirements for government agencies to follow relative to small businesses when purchasing goods and services from the private sector.

Together, these laws and regulations dictate both how much government spending must be awarded directly to qualified small businesses and of contracts awarded to large businesses, how much of those awards must then, in turn, be subcontracted to small businesses. The market impact of these laws creates an industry of teaming—large businesses seeking small business subcontractors and small businesses seeking large prime contractors. Small businesses, acting as Prime contractors, also seek large businesses to be their subcontractors.

Both large and small businesses, in the search for teaming partners, are limited by their access to information about other possible vendors. Accordingly, without knowledge of other businesses' capabilities, these businesses may miss opportunities for successful prime-subcontractor teaming.

### SUMMARY OF THE PRESENT INVENTION

Various exemplary embodiments of the present disclosure may demonstrate one or more of the invention features. Other features and advantages of this invention will become apparent from the following detailed description of the presently preferred embodiment of the invention, taken in conjunction with the accompanying drawings.

In accordance with an exemplary embodiment, a prime-subcontractor teaming system includes a vendor interface and a solicitation document interface. The system further includes a teaming analyzer in communication with the vendor interface and the solicitation document interface. The teaming analyzer includes a government agency code module in communication with government agency code data, vendor data, and solicitation document data. The government agency code module associates government agency codes with vendor data and solicitation data. The teaming analyzer further includes modules providing competitive position analysis, the modules including an opportunity evaluation analysis module, a preferred vendor analysis module, and a suggested vendor analysis module. The competitive position analysis modules are in communication with associated vendor data and associated solicitation document data. The teaming analyzer further includes a bid module in communication with associated vendor data and associated solicitation document.

In accordance with a further exemplary embodiment, a method of prime-subcontractor teaming includes accessing vendor data and accessing solicitation document data. The method further includes associating the vendor data and the solicitation document data with agency codes. The method even further includes comparing the associated data and analyzing the associated data for competitive position analysis on a bid responsive to the solicitation document data. The method even further includes suggesting vendors to improve competitive position analysis.

It is to be understood that both the foregoing general description and the following detailed description are exemplary and explanatory only and are not restrictive of the present disclosure or claims.

### BRIEF DESCRIPTION OF THE DRAWINGS

The drawings referenced herein are incorporated in and form part of the specification. The drawings illustrate one or more exemplary embodiments of the present disclosure and together with the description serve to explain various principles and operations. Implications that the drawings illustrate all embodiments of the invention are not to be made.

FIG. 1 illustrates a block diagram of prime-subcontractor teaming system.

FIG. 2 illustrates a flow diagram showing registering a vendor representative with a prime-subcontractor teaming system.

FIG. 3 illustrates a flow diagram showing registering a vendor with a prime-subcontractor teaming system.

FIG. 4 illustrates a flow diagram showing registering a solicitation document with a prime-subcontractor teaming system.

FIG. 5 illustrates a flow diagram showing establishing a baseline competitive position.

FIG. 6 illustrates a flow diagram showing creating a preferred teaming project.

FIG. 7 illustrates a flow diagram showing creating a suggested teaming project.

FIG. 8 illustrates a flow diagram showing improving teaming bid success.

### DETAILED DESCRIPTION OF THE INVENTION

Reference will now be made in detail to various exemplary embodiments of the present disclosure, examples of which are illustrated in the accompanying drawings.

It will be readily understood that the components of the present invention, as generally described and illustrated in the figures herein, may be arranged and designed in a wide variety of different configurations. Thus, the following detailed description of the embodiments of the methods and system of the present invention, as presented in the figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearance of the phrases “a select embodiment,” “in one embodiment,” or “in an embodiment” in various places throughout this specification are not necessarily referring to the same embodiment.

Features, structure, or characteristics described herein may be combined in any suitable manner in one or more embodiments. One skilled in the relevant art will recognize, however, that the invention may be practiced without one or more of the specific details, or with other methods, components, or materials. In other instances, well-known materials or processes are not shown or described in detail to avoid obscuring aspects of the invention. The following description, which shows by way of illustration the specific embodiment in which the invention may be practiced, is intended only by way of example. That is, the following description simply illustrates certain selected embodiments of methods and systems that are consistent with the invention as claimed herein. It is to be understood that other embodiments may be utilized because changes may be made without departing from the scope of the present invention.

Laws and regulations dictate both how much government spending must be awarded directly to qualified small businesses and of contracts awarded to large businesses, how much of those awards must then, in turn, be subcontracted to small businesses. The market impact of these laws may create an industry of teaming—large and small businesses seeking teaming partners.

For the most part, both the large and small businesses may seek to develop relationships and find teaming partners through networking and contacts. This approach may pose challenges to both large and small businesses as the ability to find better-qualified large and small business teaming partners may rely primarily on historical relationships, searches of stale, Government-hosted databases, or blind internet searching. Government agencies may suffer, as bringing better, truly innovative, cost-effective and efficient solutions to the challenges facing the Federal Government is often relegated to what has always been done. It may remain difficult for new solutions and technologies, particularly those created by small businesses, to “break into” the federal contract marketplace. Accordingly, the present invention disclosed herein may enable government buyers to benefit from best available solutions, help large and small businesses find partners with which to collaborate to meet government objectives and challenges, bring efficiency to the process of finding teaming partners, or create a system of faster speed-to-market for innovative small businesses to provide goods and services to the Federal Government.

The present invention may remove human judgment, prior experience and knowledge, and bias from the process of defining and developing teaming relationships. This solution may ultimately result in better solutions provided to the government for the billions of dollars in goods and services procured each year. Also, prime-subcontractor bids may improve by knowing which combinations of teams successfully bid or unsuccessfully bid on solicitation documents. Accordingly, the present invention may improve on traditional processes for identifying contract partnerships, and, at the same time, may continuously improve its process using updated contract success data.

The disclosure presented herein may identify vendors as parties, alone or in a partnership, responding to a solicitation document. The word “vendor,” as used herein, may describe a large or small business. Additionally, the term, “vendor,” as used herein, may describe a prime or subcontractor. As used herein, vendor or vendors may identify a prime contractor or contractors or a subcontractor or subcontractors. Accordingly, vendors may be businesses interested in submitting a bid to provide services or goods to the Federal Government.

Federal government contracting begins with a solicitation document. The solicitation document gives notice to the private sector that the Federal Government is seeking a purchase of goods and services from the private sector. Common examples of solicitation documents employed by the Federal Government may include a Request for Proposal (RFP), a Request for Quote (RFQ), or a Request for Task Order Proposal (RTEP). The solicitation document generally comprises a Scope of Work (SOW), which may identify requirements for the goods and services sought for purchase. For a vast majority of solicitation documents, the SOW may comprise of a series of “shall” statements that define what the Government is buying based on what the contractor is required to do. For example, a SOW may state, “The Contractor shall provide an education program for network providers in accordance with TOM, Chapter 11.” Additionally, the solicitation document may comprise evaluation criteria, used to evaluate submitted bids in view of the SOW. Accordingly, a solicitation document may identify requirements and evaluation criteria for vendors interested in providing provide goods and services to the Federal Government.

A vendor may respond to a solicitation document with a bid. The bid identifies a single, primary contact offering the bid—a prime. The prime may also be referred to herein as a primary contractor or prime vendor. The bid may also identify other government contractors, referred to herein as subcontracting vendors or subcontractors. Both prime and subcontractor vendors may generally identify individuals on a team performing required services or providing required goods. The bid may further identify how the prime and each subcontractor provide the services required in the SOW. Accordingly, a bid may identify a teaming partnership created to provide goods or services required by a solicitation document.

The present invention may seek to identify prime-subcontractor teaming partnerships. To do so, the present invention may identify a common framework or language across vendor capabilities and government requirements. Additionally, the present invention may identify or apply the common framework or language to vendor prior work evaluations and government evaluation criteria. In an exemplary embodiment, the system and methods of the present invention create a common framework or language based on a government agency code—the North American Industry Classification System (NAICS) code. The NAICS code classifies business establishments for the purpose of collecting, analyzing, and publishing statistical data related to the U.S. economy. Specifically, the NAICS industry codes define establishments based on the activities in which they are primarily engaged. The NAICS code is provided for exemplary purposes of government agency codes, and is not meant to be limiting. A person of ordinary skill the government contract space may identify alternative government agency codes supporting a common language or platform for prime-subcontractor teaming analysis. Those alternative codes may be considered herein with the present disclosure. Accordingly, the present invention considers a code commonly used by government agencies in solicitation documents to create a common framework and analysis for prime-subcontractor teaming analysis.

As described herein above, a SOW statement may require that, “The Contractor shall provide an education program for network providers in accordance with TOM, Chapter 11.” In the example statement above, one might assume that “education” is the key component of the work being required. However, the NAICS codes associated with education may include: 611710 (Educational Support Services) and 923110 (Administration of Education Programs). Presumably, the example shall statement above would be assigned to 923110. However, the detail of the 923110 record also needs to be understood as it says: “923110 Administration of Education Programs. The industry issuing the shall statement may comprise government establishments primarily engaged in the central coordination, planning, supervision and administration of funds, policies, intergovernmental activities, statistical reports and data collection, and centralized programs for educational administration. Illustrative examples of possible government establishments may include the following: nonoperating, public administration, State education departments, Education statistics centers, government, University regents or boards, government.” Indeed, upon further review, the SOW statement provided herein above may not be requesting a “government establishment” but rather a non-governmental entity providing what could also be titled training. The NAICS search for training may return results including: 611410 (Software application training), 611430 (Professional development training) and 624310 (Job training). The appropriate NAICS code for our example SOW is 611430. Accordingly, a NAICS code may be associated with a SOW.

As mentioned above, the solicitation document may be associated with a single NAICS code. Further, each requirement in the solicitation document may be associated with a NAICS code. Accordingly, the solicitation document and details of the required services or products may be associated with a code commonly used by government agencies.

As discussed above, the present invention, as described herein, applies a common framework or language across both government requirements and vendor capabilities. With that in mind, the present invention associates an NAICS code to a vendor capability. A typical Information Technology company, for example, may have a primary NAICS code such as 541511 (Software analysis and design services, custom computer). However, several other NAICS codes may also apply to a portion of the services the vendor may provide. In an exemplary embodiment, an Information Technology company may also provide services that could be classified as 541512 (Information management computer systems integration design services), 541519 (Software installation services, computer), or 611410 (Computer software training). Accordingly, both vendor capability and SOW requirements are associated with a code commonly used by government agencies.

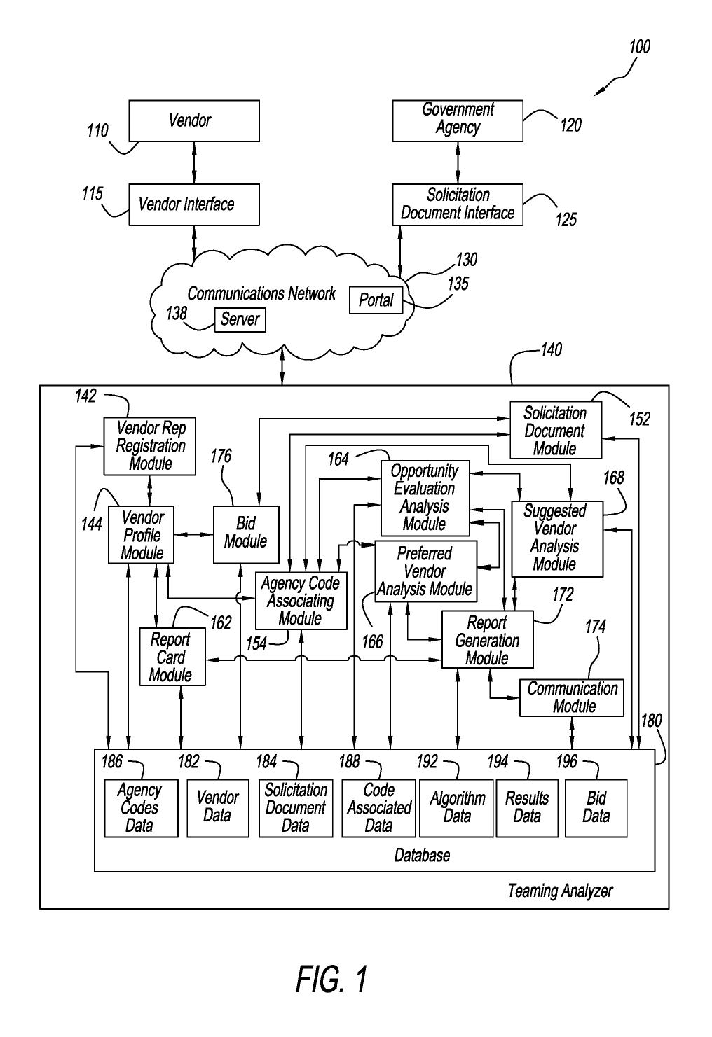

In an exemplary embodiment, the present invention may use a framework comprising agency code-associated data to suggest prime-subcontractor teaming combinations for success on contract bids. The data may originate with vendors, either prime or subcontractors, and government agencies, including government agency procurement offices. FIG. 1 illustrates a block diagram of an exemplary embodiment of a prime-subcontractor teaming system (100) in accordance with the present disclosure. In an exemplary embodiment, the system (100) may comprise a vendor (110) and a government agency (120). In a further exemplary embodiment, the vendor (110) and the government agency (120) may interface via a communications network (130) with a teaming analyzer (140). In an exemplary embodiment, the vendor (110) may interface with the communications network (130) via a vendor interface (115) to provide vendor data to the teaming analyzer (140). Similarly, in an exemplary embodiment, the government agency (120) may interface with the communications network (130) via a solicitation document interface (115) to provide solicitation document data to the teaming analyzer (140). In an embodiment, the communications network may comprise a portal (135) and a server (138). The structure of the communications network (130) is provided for exemplary purposes and is not meant to be limiting. In an exemplary embodiment, the teaming analyzer (140) may further comprise a database (180) for storing vendor data and solicitation document data, as described herein above. Accordingly, vendors and government agencies may communicate data to the teaming analyzer and the team analyzer may store the data.

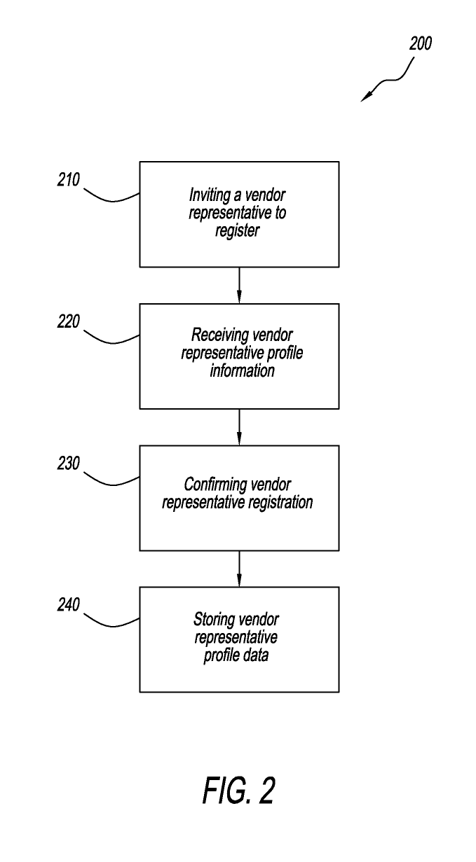

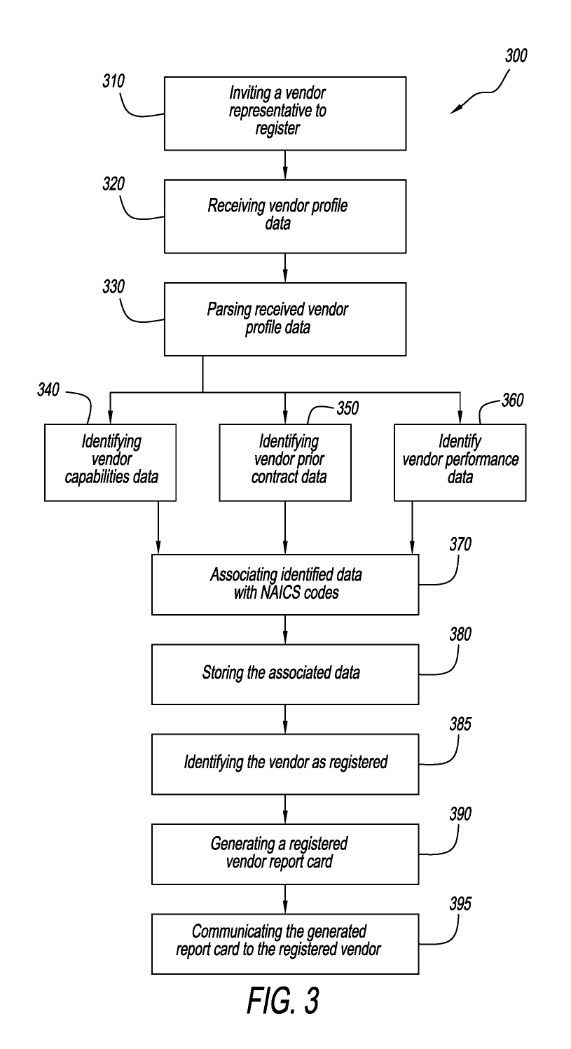

As described herein above, a vendor (110) may communicate vendor data to a teaming analyzer (140) via a communications network (130). As described herein below in FIG. 2 vendor data may comprise, for example, vendor representative data. In an embodiment, the teaming analyzer (140) may comprise a vendor representative registration module (142) to register a vendor representative with the prime-subcontractor teaming system (100). As described in FIG. 3, herein below, in another embodiment, the teaming analyzer (140) may comprise a vendor profile module (144) to collect vendor profile data and register a vendor with the prime-subcontractor teaming system (100). As described in FIG. 3, vendor data may comprise vendor profile data, which may comprise, for example, vendor contact information, vendor capability data, vendor prior contract data, and vendor evaluation data. In a further embodiment, the present invention may store vendor data in a vendor data table (182) in a database (180). Accordingly, a teaming analyzer may capture and store vendor data.

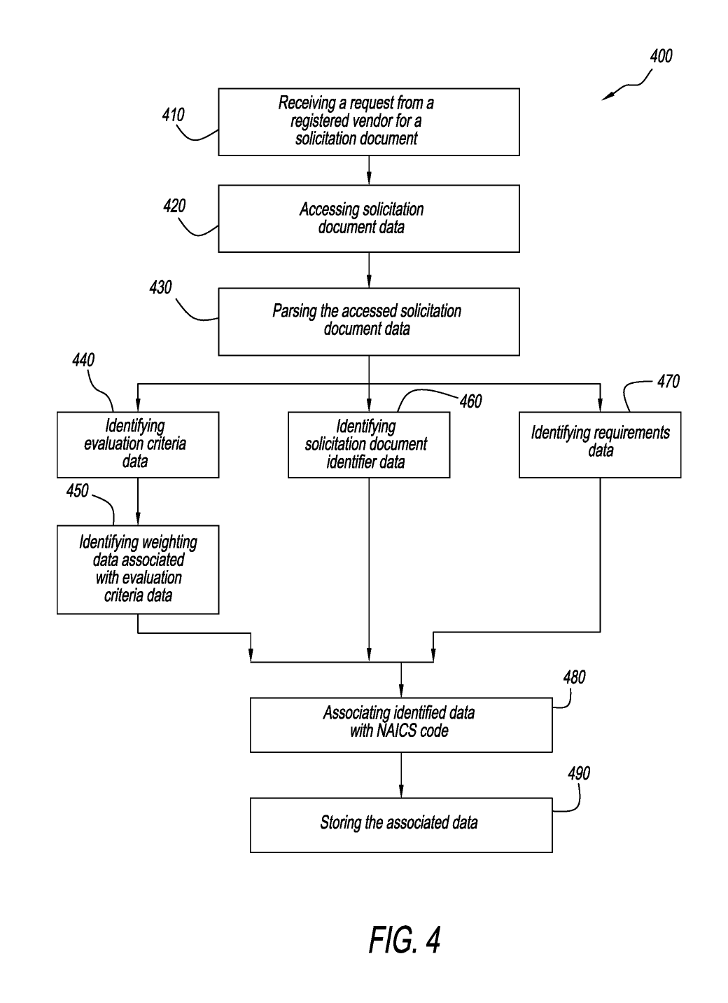

As described herein above, a government agency (120) may communicate solicitation document data to a communications network (130). A teaming analyzer (140) may access solicitation document data via the communications network (130). As described herein below in FIG. 4, in an exemplary embodiment, solicitation document data may comprise, for example, solicitation document identifier data, requirements data, evaluation criteria data, and weighting data associated with the evaluation criteria data. In an embodiment, the teaming analyzer (140) may comprise a solicitation document module (152) to access solicitation document data. In a further embodiment, the present invention may store solicitation document data in a solicitation document data table (184) in a database (180). Accordingly, a teaming analyzer may capture and store solicitation document data.

As described herein above, a common framework for prime-subcontractor teaming analysis may comprise a government agency code. As described herein below in FIG. 3 and FIG. 4, in an exemplary embodiment of the present invention, NAICS codes may be associated with vendor data and solicitation document data. An exemplary embodiment of a prime-subcontractor teaming system (100) may comprise a database (180) with an agency code data table (186). A person of ordinary skill in data management may know various embodiments for maintaining current agency code data, which are contemplated in the present disclosure. In an exemplary embodiment, a teaming analyzer (140) may further comprise an agency code associating module (154). As described herein below in FIG. 3 and FIG. 4, in an exemplary embodiment, the agency code associating module (154) may associate, for example, NAICS codes with vendor capabilities, vendor prior contract data, vendor evaluation data, requirements data, and evaluation criteria data. In a further embodiment, the present invention may store agency code-associated data in a code-associated data table (188) in a database (180). Accordingly, a teaming analyzer may associate vendor and solicitation document data with government agency codes.

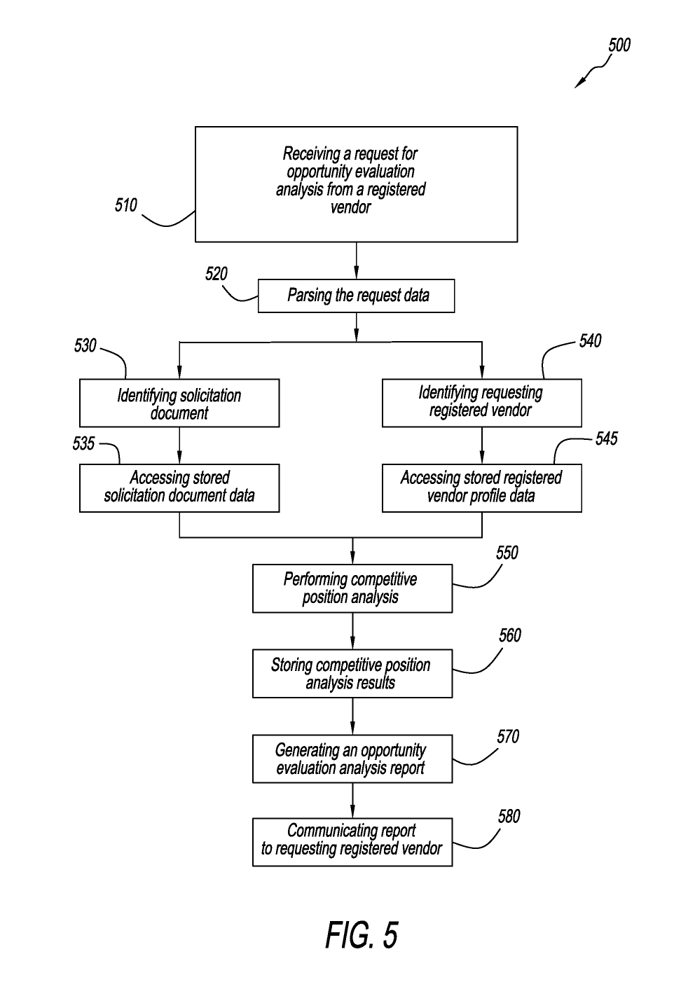

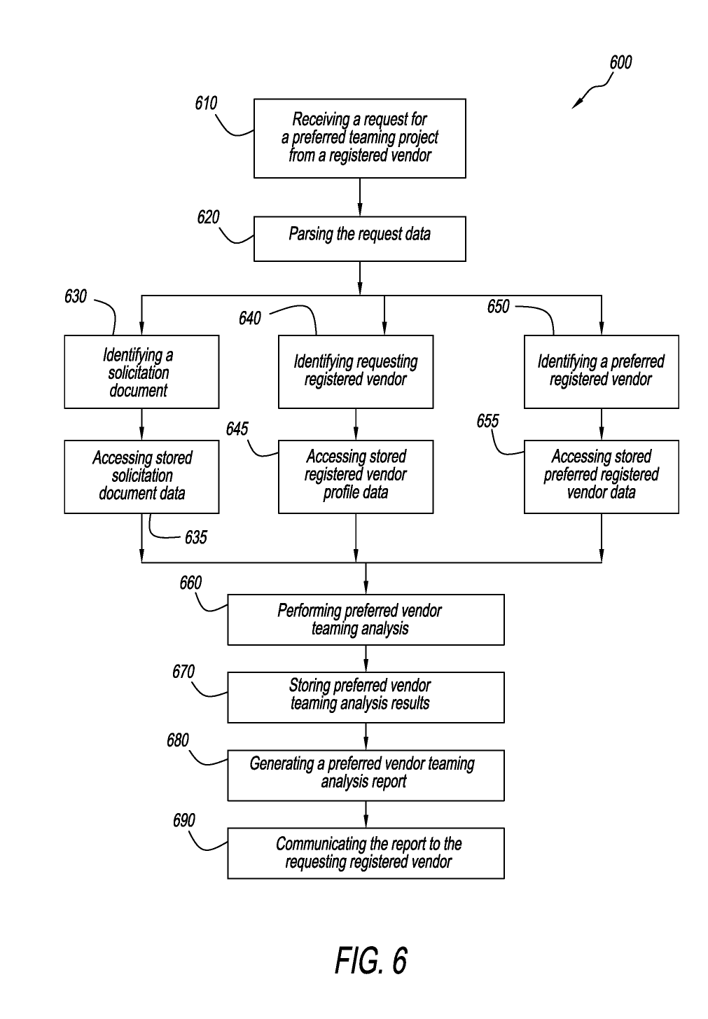

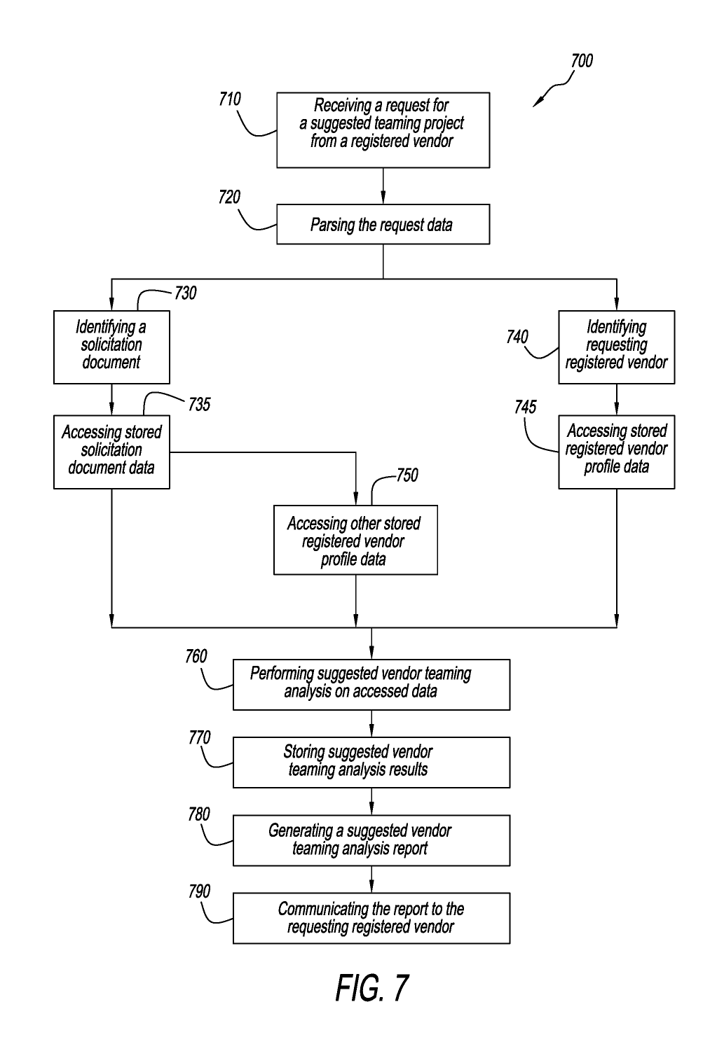

As described in FIG. 3, FIG. 5, FIG. 6, and FIG. 7, embodiments of the present invention provide analysis for vendor decision making. For example, a vendor may be interested in a Report Card, showing the vendor's strengths and weaknesses, generally. In another example, a vendor may be interested in an Opportunity Evaluation Analysis Report, showing the vendor's competitive position if the vendor independently submits a bid. In a further example, a vendor may be interested in a Preferred Vendor Teaming Report, showing the vendor's competitive position if the vendor submits a bid with a preferred, known vendor. In another embodiment, a vendor may be interested in a Suggested Vendor Teaming Report, showing the vendor's competitive position if the vendor submits a bid with another vendor suggested by a prime-subcontractor teaming system (100) in accordance with the present invention. With this in mind, in an exemplary embodiment, the present invention may comprise a teaming analyzer (140) further comprising analysis modules, such as a report card module (162), an opportunity evaluation analysis module (164), a preferred vendor analysis module (166), and a suggested vendor analysis module (168). In an exemplary embodiment, the teaming analyzer (140) may further comprise a database (180), which may further comprise an algorithm data table (192). The algorithm data table (192) may store variables and values associated with algorithms used by, for example, the report card module (162), the opportunity evaluation analysis module (164), the preferred vendor analysis module (166), and the suggested vendor analysis module (168). In a further exemplary embodiment, the teaming analyzer (140) may further comprise a database (180), which may further comprise a results data table (194). The results data table (194) may store results generated during analysis by, for example, the report card module (162), the opportunity evaluation analysis module (164), the preferred vendor analysis module (166), and the suggested vendor analysis module (168). In a further exemplary embodiment, a report generation module (172) and a communications module (174) may formalize and communicate results of analysis performed by, for example, the report card module (162), the competitive position analysis module (164), the preferred vendor analysis module (166), and the suggested vendor analysis module (168). Accordingly, data may be analyzed and the analysis results may be stored and communicated.

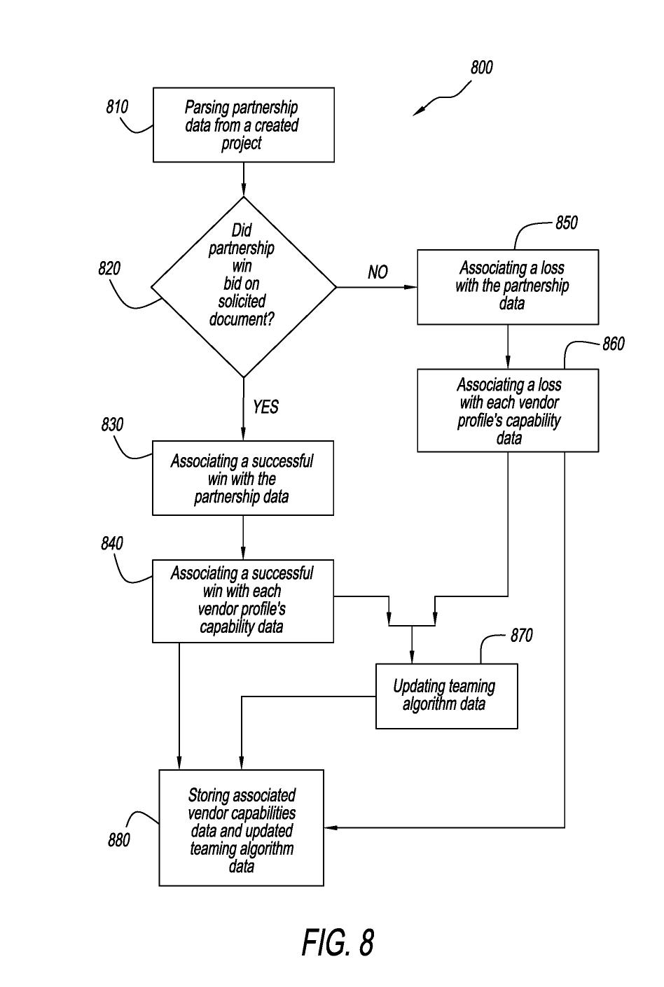

As described in FIG. 8, an exemplary embodiment of a prime-subcontractor teaming system (100) may provide for improving variables and values associated with analysis. For example, in an exemplary embodiment, prime-subcontractor teaming data associated with a successful bid may be captured and distinguished from prime-subcontractor teaming data associated with a losing bid. With this in mind, in an exemplary embodiment, the present invention may comprise a teaming analyzer (140) further comprising a bid module (176) for capturing bid proposal information, such as team member information and teaming agreements, as well as bid success information. In a further embodiment of the present invention, the teaming analyzer (140) may comprise a database (180) further comprising a bid data table (196) for capturing the aforementioned bid information. In a further exemplary embodiment, the bid module (176) may interact with the aforementioned algorithm data table (192) to update the variables and values associated with algorithms used by, for example, the report card module (162), the opportunity evaluation analysis module (164), the preferred vendor analysis module (166), and the suggested vendor analysis module (168). Accordingly, prime-subcontractor information may be captured prior to submitting a bid, and bid success may be captured to improve success of future bid.

Those of ordinary skill in the art will understand, however, that the present disclosure is not limited to the embodiments illustrated in FIG. 1. That is, the present disclosure contemplates various system configurations, including various exemplary embodiments for capturing vendor data and solicitation document data, storing agency code data, vendor data, solicitation document data, agency code associated data, algorithm data, results data, and bid data, and analyzing and reporting analysis results.

In an exemplary embodiment of the present invention, a vendor interested in forming prime-subcontractor teaming partnerships may access the system described in FIG. 1. In an example, the vendor may identify a vendor representative, who may initiate engagement with the prime-subcontractor teaming system (100) and who may act on the vendor's behalf. In an exemplary embodiment of the present invention, following methods described herein below, the system described in FIG. 1 may identify prime-subcontractor teaming partnerships to submit bid. Using this information, a vendor representative may, for example, execute agreements with identified partners to bid on a solicitation document, identify team members for the bid, and participate in preparing the bid. Should the Federal Government accept the prepared bid, a vendor representative may work with a teaming partner to execute the solicited work. Accordingly, the vendor representative may act as a single point of contact for a vendor in preparing and executing a winning bid.

As described above, the vendor representative may initiate engagement with the system described in FIG. 1. FIG. 2 illustrates a flow diagram of an exemplary embodiment of registering a vendor representative with a prime-subcontractor teaming system (200) in accordance with the present disclosure. In an exemplary embodiment, registering a vendor representative with a prime-subcontractor teaming system (200) may comprise inviting a vendor representative to register (210) with the teaming system. A further exemplary embodiment may include receiving vendor representative profile information (220). Examples of vendor representative profile information, which are not meant to be limiting, may comprise the following: business contact information, employee identifying information; employee skills, industry experience, languages, social media addresses, or education. The created profile information, as provided herein, are not meant to be limiting, and are provided for exemplary purposes only. In an exemplary embodiment, the prime-subcontractor teaming system of the present invention may interact with the vendor representative through a vendor interface and communications network, as discussed in FIG. 1. For example, inviting a vendor representative to register (210) may comprise sending an email correspondence to the vendor representative. All methods for inviting a vendor representative to register (210) and receiving vendor representative profile information (220) are contemplated herein. Registering a vendor representative with a prime-subcontractor teaming system (200) may further comprise confirming vendor representative registration (230) and storing vendor representative profile data (240). In an exemplary embodiment, the vendor representative profile date is stored in a database, as described in FIG. 1. Accordingly, an invited vendor representative may register with a prime-subcontractor teaming system.

In an exemplary embodiment of the present invention, a vendor representative may register a vendor, and, in doing so, may expand each vendor's reach and awareness of other vendors seeking to work with the Federal Government. FIG. 3 illustrates a flow diagram of an exemplary embodiment of registering a vendor with a prime-subcontractor teaming system (300) in accordance with the present disclosure. Registering a vendor with a prime-subcontractor teaming system (300) may comprise inviting a vendor to register (310) and receiving vendor profile data (320). In an exemplary embodiment, as described herein above, a vendor representative may act on behalf of a vendor to register the vendor with the prime-subcontractor teaming system, as described in FIG. 1. The vendor representative, in an exemplary embodiment, may interact with the with the prime-subcontractor teaming system of the present invention through a vendor interface and communications network, as discussed in FIG. 1. For example, inviting a vendor to register (310) may comprise sending an email correspondence to the vendor representative. All methods for inviting a vendor to register (310) and receiving vendor profile information (320) are contemplated. Examples of vendor profile information, which are not meant to be limiting, may comprise the following: vendor capabilities and vendor prior performance on government contracts. The created profile information, as provided herein, are not meant to be limiting, and are provided for exemplary purposes. Accordingly, registering a vendor may comprise receiving vendor capability and performance data.

In a further exemplary embodiment, registering a vendor with a prime-subcontractor teaming system (300) may comprise parsing received vendor profile data (330). As described above, a prime-subcontractor teaming system of the present invention may require a common framework to analyze government requirements against vendor capabilities. In an exemplary embodiment, parsing received vendor profile data (330) may support creating the common framework. For example, parsing the vendor received profile data (330) may be followed by identifying vendor capabilities data (340), identifying vendor prior contract data (350), and identifying vendor performance data (360). Accordingly, received vendor capability and performance data may be parsed to support a common analysis framework.

In an embodiment of the present invention, identifying vendor performance data (360) may comprise receiving any combination of the following data: workmanship, timeliness, autonomy, contract objectives, ratings, quality, or cost control. The categories herein are provided for exemplary purposes and are not meant to be limiting. In an exemplary embodiment, identifying vendor performance data (360) may comprise receiving vendor performance data from the vendor or from a third-party in a position to evaluate the vendor's prior contract performance. In another exemplary embodiment, receiving vendor profile data (320) may comprise, at least, receiving permissions to access third-party evaluations of prior contract performance. In an exemplary embodiment, a category of performance, such as workmanship, may require the vendor or third-party to assess vendor performance using a numeric scale. In an exemplary embodiment, a numeric scales for workmanship may comprise the following: 5—Easy to work with, 4—Somewhat easy to work with, 3—Somewhat difficult to work with, or 2—Difficult to work with. Any category of performance data may comprise a rating scale. In an exemplary embodiment, performance data is converted to numeric values for ease of analysis. The scale and categories of ratings are provided for exemplary purposes and are not meant to be limiting. It is contemplated by the present disclosure that a rating system may be provided for each category of performance. Accordingly, vendor performance data may be received.

After identifying vendor capabilities data (340), identifying vendor prior contract data (350), and identifying vendor performance data (360), registering a vendor with the teaming system (300) may comprise associating identified data with NAICS codes (370). Vendor capability data may be associated with government agency requirements. Vendor prior contract data may be associated with solicitation documents. As discussed herein above, solicitation document requirements and solicitation documents, themselves, may be associated with NACIS codes. In a further exemplary embodiment, vendor performance data may be associated with a government agency code. For example, performance data may be specific to government contract performance, and the government contract may be associated with an NAICS code. Accordingly, in an exemplary embodiment of the present invention, vendor profile data may be associated with a government agency code, which supports a common framework for competitive position analysis.

In a further exemplary embodiment, registering a vendor with the teaming system (300) may comprise storing the associated data (380) and identifying the vendor as registered (385). In a further exemplary embodiment, registering a vendor with the teaming system (300) may comprise generating a vendor report card (390) and communicating the generated report card to the registered vendor (395). In an exemplary embodiment, a registered vendor report card may comprise identified vendor capabilities, identified opportunities for improvement in the vendor's general areas of products and services, and analysis of a vendor's capabilities and opportunities for improvement relative to other registered vendors. Accordingly, a vendor report card may provide a registered vendor with a review of capabilities to offer to prime-subcontractor teaming partnerships and may also provide opportunities for improvement.

In an exemplary embodiment of the present invention, a registered vendor may request information about a solicitation document because the registered vendor may be interested in placing a bid on the solicitation document. FIG. 4 illustrates a flow diagram of an exemplary embodiment of registering a solicitation document with a prime-subcontractor teaming system (400) in accordance with the present disclosure. In an exemplary embodiment, the system of the present invention may receive direct or indirect notice that the Federal Government issued a solicitation document. In an embodiment of the present invention, for example, registering a solicitation document with the prime-subcontractor teaming system (400) may comprise receiving a request from a registered vendor for a solicitation document (410). In this way, in an embodiment, a registered vendor may provide the notice that the Federal Government issued a solicitation document. In a further embodiment, for example, after receiving a request from a registered vendor for a solicitation document (410), registering a solicitation document with the prime-subcontractor teaming system (400) may comprise accessing solicitation document data (420). For example, the present invention may receive direct or indirect access to the solicitation document, including, at least, access to solicitation document identifier data, requirements data, and criteria data used to evaluate a vendor's or vendors' bid against the solicitation document. Mechanisms for accessing the solicitation document data, directly or indirectly, are contemplated, herein. Accordingly, vendor requests may initiate registering a solicitation document.

In an exemplary embodiment, registering a solicitation document with the prime-subcontractor teaming system (400) may comprise parsing the accessed solicitation document data (430). In an embodiment of the present invention, after parsing the received solicitation document data (430), the present invention may comprise identifying evaluation criteria data (440). Each government solicitation document generally contains a description of evaluation factors or criteria based on which the Federal Government will make the contract award decision. For example, a government agency may evaluate a bid based on the technical competencies of a vendor, as well as costs. Accordingly, evaluation criteria data may be parsed from solicitation document data.

In an exemplary embodiment of the present invention, evaluation criteria data may consider the following: (1) Technical Evaluation; (2) Past Performance Evaluation; and (3) Cost Evaluation. In an embodiment, Technical Evaluation may comprise, for example, Merit, Risk, and Assessment criteria. Similarly, in an embodiment, Past Performance Evaluation may comprise Relevance, Confidence, and Decency criteria. Also, similarly, in an embodiment, Cost Evaluation may comprise Reasonableness and Realism criteria. The evaluation criteria and categories are provided for exemplary purposes, and are not meant to be limiting. Any category of evaluation criteria data may comprise a rating scale. In an exemplary embodiment, evaluation criteria data may be converted to numeric values for ease of analysis. For example, in an embodiment of the present invention, a numeric scale for an evaluation criterion, such as Merit, may comprise the following: 5-outstanding, 4-good, and 3-acceptable, 2-marginal, and 0-unacceptable. It is contemplated by the present disclosure that a rating system may be provided for each category of evaluation criteria data. Accordingly, evaluation criteria data may be identified.

The particular importance or weightings of each factor relative to the total may be an important component of the Federal Government's ultimate contract award decision. In an exemplary embodiment, registering a solicitation document with the prime-subcontractor teaming system (400) may comprise identifying weighting data associated with the evaluation criteria data (450). For example, a Lowest Prime Technically Acceptable solicitation document may seek bids offering lowest cost solutions, and weigh aspects of a bid, accordingly. In an alternative example, a Best Value solicitation document may seek bids offering leading edge, innovative solutions, and may weigh aspects of the bid accordingly. Accordingly, weights associated with evaluation criteria may be identified.

After parsing received solicitation document data (430), registering a solicitation document with the prime-subcontractor teaming system (400) may further comprise identifying solicitation document identifying data (460). As described herein above, in an exemplary embodiment, the statement, “The Contractor shall provide an education program for network providers in accordance with TOM, Chapter 11,” may identify a solicitation document. In addition to identifying evaluation criteria data (440) and identifying solicitation document identifier data (460), registering a solicitation document with the prime-subcontractor teaming system (400) may comprise identifying requirements data (470). For example, the solicitation document identified herein above may include requirement data, such as “The Contractor shall develop professional development training programs.” Accordingly, evaluation criteria data, evaluation criteria weighing data, solicitation document identifier data, and requirements data may be identified from parsed solicitation document data.

As with registering a vendor as discussed herein above in FIG. 3, the present invention provides for use of a common framework to analyze accessed solicitation document data against vendor capability and performance data. Frequently, government solicitation documents are associated with an identifying code, such as an NAICS code. In a further exemplary embodiment, each requirement data may be associated with an identifying code, such as an NACIS code. Similarly, each evaluation criteria data may be associated with a requirement data. As described herein above, each requirement data may be associated with an identifying code, such as an NAICS code; therefore, each evaluation criteria data may be associated with an NAICS code. To that end, in an exemplary embodiment, the present invention may comprise associating identified data, such as evaluation criteria data, weight data, solicitation document identifier data, or requirements data, with NAICS codes (480) and storing the associated data (490). Accordingly, solicitation document data may be associated with government codes.

In an exemplary embodiment of the present invention, a registered vendor interested in placing a bid on a solicitation document may have an interest in knowing the vendor's competitive position, independent of a prime-subcontractor partnership. In an exemplary embodiment, the present invention may provide competitive position analysis for the registered vendor. FIG. 5 illustrates a flow diagram of an exemplary embodiment of establishing a baseline competitive position (500) in accordance with the present disclosure. In an exemplary embodiment, establishing a baseline competitive position (500) may comprise receiving a request for opportunity evaluation analysis from a registered vendor (510) and parsing the request data (520). The request may identify the registered vendor and a solicitation document of interest to the registered vendor. As described in FIG. 4, receiving a request from a registered vendor for a solicitation document (410) may initiate registering a solicitation document with a prime-subcontractor teaming system (400). With that in mind, in an exemplary embodiment of the present invention, receiving a request for opportunity evaluation analysis from a registered vendor (510) may initiate registering a solicitation document with a prime-subcontractor teaming system (400). Accordingly, registered vendor requests may initiate registering a solicitation document or establishing a baseline competitive position, or any combination thereof.

In an exemplary embodiment, parsing the request data (520) may follow receiving a request for opportunity evaluation analysis from a registered vendor (510). In a further exemplary embodiment, parsing the request data (520) may lead to identifying a solicitation document (530) and accessing stored solicitation document data (535). As described in FIG. 4, registering a solicitation document with the prime-subcontractor teaming system (400) may comprise storing solicitation document data associated with government agency codes, such as NAICS codes. Accordingly, accessing stored solicitation document data may comprise accessing stored associated-solicitation document data.

Similarly, in an exemplary embodiment, parsing the request data (520) may lead to identifying the requesting registered vendor (540) and accessing stored requesting registered vendor profile data (545). As described in FIG. 3, registering a vendor with a prime-subcontractor teaming system (300) may comprise storing vendor profile data associated with government agency codes, such as NAICS codes. Accordingly, accessing stored requesting registered vendor profile data may comprise accessing stored associated-registered vendor profile data.

A exemplary embodiment of the present invention may further comprise performing competitive position analysis (550). In an exemplary embodiment, competitive position analysis aligns vendor capability and performance data with government agency requirements and evaluation criteria data. As described herein above, and in FIG. 3 and FIG. 4, NAICS codes may be associated with solicitation document data and registered vendor profile data. In an exemplary embodiment of the present invention, performing competitive position analysis (550) may comprise aligning stored associated-solicitation document data with stored associated-registered vendor profile data. In an exemplary embodiment of the present invention, competitive position analysis may, for example, consider a vendor's competition position relative to identified vendors or system-registered vendors. In a further exemplary embodiment, after performing competition position analysis (550), the present invention may further comprise storing competitive position analysis results (560). Following storing competitive position analysis results (560), an exemplary embodiment of the present invention may comprise generating an opportunity evaluation analysis report (570) and communicating the report to the requesting vendor (580). Accordingly, a registered vendor may request opportunity evaluation analysis to learn the vendor's independent, competitive position for an identified solicitation document.

A registered vendor may also consider teaming with known, or preferred, registered vendors, either as a prime or subcontractor, to improve the registered vendor's competitive position described in FIG. 5. FIG. 6 illustrates a flow diagram of an exemplary embodiment of creating a preferred teaming project (600). In an exemplary embodiment, creating a preferred teaming project (600) may begin with receiving a request for a preferred teaming project from a registered vendor (610). In a non-limiting exemplary embodiment, as described in FIG. 5, establishing a baseline competitive position (500) may comprise, at least, receiving a request for opportunity evaluation analysis from a registered vendor (510). In many cases, a registered vendor may assume partnering with a prime or subcontractor may be necessary for bid success. In these cases, in an alternative embodiment of the present invention, receiving a request for a preferred teaming project from a registered vendor (610) may comprise, for example, receiving a request for opportunity evaluation analysis from a registered vendor (510) or, for example, performing competitive position analysis (550). Accordingly, competitive position analysis and teaming analysis may be performed independently or dependently.

In an exemplary embodiment, creating a preferred teaming project (600) may comprise parsing the request data (620). The request data may identify the registered vendor, at least one preferred registered vendor, and a solicitation document of interest to the registered vendor. As described in FIG. 4, receiving a request from a registered vendor for a solicitation document (410) may initiate registering a solicitation document with a prime-subcontractor teaming system (400). With that in mind, in an exemplary embodiment of the present invention, receiving a request for a preferred teaming project from a registered vendor (610) may initiate registering a solicitation document with a prime-subcontractor teaming system (400). Accordingly, registered vendor requests may initiate registering a solicitation document or initiate preferred teaming analysis, or any combination thereof.

In an exemplary embodiment, parsing the request data (620) may follow receiving a request for a preferred teaming project from a registered vendor (610). In a further exemplary embodiment, parsing the request data (620) may lead to identifying a solicitation document (630) and accessing stored solicitation document data (635). As described in FIG. 4, registering a solicitation document with the prime-subcontractor teaming system (400) may comprise storing solicitation document data associated with government agency codes, such as NAICS codes. Accordingly, accessing stored solicitation document data may comprise accessing stored associated-solicitation document data.

Similarly, in an exemplary embodiment, parsing the request data (620) may lead to identifying the requesting registered vendor (640) and identifying a preferred registered vendor (650). In an exemplary embodiment, identifying the requesting registered vendor (640) and identifying a preferred registered vendor (650) may lead to accessing stored requesting registered vendor profile data (645) and accessing stored preferred registered vendor data (655), respectively. As described in FIG. 3, registering a vendor with a prime-subcontractor teaming system (300) may comprise storing vendor profile data associated with government agency codes, such as NAICS codes. Accordingly, accessing stored requesting registered vendor profile data or preferred registered vendor profile data may comprise accessing stored associated-registered vendor profile data.

A exemplary embodiment of the present invention may further comprise performing preferred vendor teaming analysis (660). In an exemplary embodiment, preferred vendor teaming analysis aligns registered vendor capability and performance data, enhanced with preferred vendor capability and performance data, with government agency requirements and evaluation criteria data. As described herein above, and in FIG. 3 and FIG. 4, NAICS codes may be associated with solicitation document data and registered vendor profile data. In an exemplary embodiment of the present invention, performing preferred vendor teaming analysis (660) may comprise aligning stored associated-solicitation document data with stored associated-registered vendor profile data. In an exemplary embodiment of the present invention, preferred vendor teaming analysis may, for example, consider a vendor's enhanced competition position relative to identified vendors or system-registered vendors. In a further exemplary embodiment, after performing preferred vendor teaming analysis (660), the present invention may further comprise storing preferred vendor teaming analysis results (670). Following storing preferred vendor teaming analysis results (670), an exemplary embodiment of the present invention may comprise generating a preferred vendor teaming analysis report (680) and communicating the report to the requesting registered vendor (690). Accordingly, a registered vendor may request preferred vendor teaming analysis to learn the vendor's competitive position as part of a prime-subcontractor team with a preferred vendor for an identified solicitation document.

A registered vendor may also consider teaming with unknown vendors, either as a prime or subcontractor, to improve the registered vendor's competitive position described in FIG. 5 and FIG. 6. FIG. 7 illustrates a flow diagram of an exemplary embodiment of creating a suggested teaming project (700). In an exemplary embodiment, creating a suggested team project (700) may begin with receiving a request for a suggested teaming project from a registered vendor (710). In a non-limiting exemplary embodiment, as described in FIG. 5, establishing a baseline competitive position (500) may comprise, at least, receiving a request for opportunity evaluation analysis from a registered vendor (510). In many cases, a registered vendor may assume partnering with an unknown prime or subcontractor may be necessary for bid success. In these cases, in an alternative embodiment of the present invention, receiving a request for a suggested teaming project from a registered vendor (710) may comprise, for example, receiving a request for opportunity evaluation analysis from a registered vendor (510) or, for example, performing competitive position analysis (550). Accordingly, competitive position analysis and teaming analysis may be performed independently or dependently.

In an exemplary embodiment, creating a suggested teaming project (700) may comprise parsing the request data (720). The request may identify the registered vendor and a solicitation document of interest to the registered vendor. As described in FIG. 4, receiving a request from a registered vendor for a solicitation document (410) may initiate registering a solicitation document with a prime-subcontractor teaming system (400). With that in mind, in an exemplary embodiment of the present invention, receiving a request for a suggested teaming project from a registered vendor (710) may initiate registering a solicitation document with a prime-subcontractor teaming system (400). Accordingly, registered vendor requests may initiate registering a solicitation document or initiate suggested teaming analysis, or any combination thereof.

In an exemplary embodiment, parsing the request data (720) may follow receiving a request for a suggested teaming project from a registered vendor (710). In a further exemplary embodiment, parsing the request data (720) may lead to identifying a solicitation document (730) and accessing stored solicitation document data (735). As described in FIG. 4, registering a solicitation document with the prime-subcontractor teaming system (400) may comprise storing solicitation document data associated with government agency codes, such as NAICS codes. Accordingly, accessing stored solicitation document data may comprise accessing stored associated-solicitation document data.

Similarly, in an exemplary embodiment, parsing the request data (720) may lead to identifying the requesting registered vendor (740). In an exemplary embodiment, identifying the requesting registered vendor (740) may lead to accessing stored requesting registered vendor profile data (745). As described in FIG. 3, registering a vendor with a prime-subcontractor teaming system (300) may comprise storing vendor profile data associated with government agency codes, such as NAICS codes. Accordingly, accessing stored requesting registered vendor profile data may comprise accessing stored associated-registered vendor profile data.

In an exemplary embodiment, accessing stored requesting registered vendor profile data (745) may lead to accessing other stored registered vendor data (750). As described in FIG. 3, registering a vendor with a prime-subcontractor teaming system (300) may comprise storing vendor profile data associated with government agency codes, such as NAICS codes. Accordingly, accessing other stored registered vendor data may comprise accessing other stored associated-registered vendor profile data.

An exemplary embodiment of the present invention may further comprise performing suggested vendor teaming analysis (760). In an exemplary embodiment, suggested vendor teaming analysis aligns registered vendor capability and performance data, enhanced with suggested vendor capability and performance data, with government agency requirements and evaluation criteria data. As described herein above, and in FIG. 3 and FIG. 4, in an exemplary embodiment, NAICS codes may be associated with solicitation document data and registered vendor profile data. In an exemplary embodiment of the present invention, performing suggested vendor teaming analysis (760) may comprise aligning stored associated-solicitation document data with stored associated-registered vendor profile data, for both a requesting registered vendor and other registered vendors. In an exemplary embodiment of the present invention, suggested vendor teaming analysis may, for example, consider a vendor's enhanced competition position relative to system-registered vendors. In a further exemplary embodiment, after performing suggested vendor teaming analysis (760), the present invention may further comprise storing suggested vendor teaming analysis results (770). Following storing suggested vendor teaming analysis results (770), an exemplary embodiment of the present invention may comprise generating a suggested vendor teaming analysis report (780) and communicating the report to the requesting registered vendor (790). Accordingly, a registered vendor may request suggested vendor teaming analysis to learn the vendor's competition position as part of a prime-subcontractor team with other registered vendors for an identified solicitation document.

As described in FIG. 5, in an exemplary embodiment, a registered vendor may request analysis for competitive position for submitting a bid on a solicitation document as a solo bidder. As described in FIG. 6 and FIG. 7, in exemplary embodiments, a registered vendor may further request competitive position analysis for submitting a bid on a solicitation document as part of a prime-subcontractor teaming partnership by creating a preferred or suggested teaming project. As described above, the project analysis may consider whether teaming with known or unknown vendors improves a requesting registered vendor's competitive position in submitting the bid. A requesting registered vendor may choose a teaming partner, and, at that point, may contact the teaming partner vendor representative. The vendor representative may work with the requesting registered vendor to develop a contract team and solicit the bid on the solicitation document. Accordingly, a requesting registered vendor may use competitive position analysis to identify teaming partners.

The robustness of the prime-subcontractor teaming system, as described in the present disclosure, may depend on the success rate of the reported teaming partnerships. With that in mind, FIG. 8 illustrates a flow diagram of an exemplary embodiment of improving teaming bid success (800) in accordance with the present disclosure. Improving teaming bid success (800) may, for example, comprise parsing partnership data from a created project (810). A requesting registered vendor may provide partnership data, or team partnership data may be received with creating a team project. For example, as described in FIG. 3, registering a vendor with a prime-subcontractor teaming system (300) may comprise identifying vendor prior contract data (350). An exemplary embodiment of the present invention may further comprise identifying whether a partnership won a bid on a solicitation document (820). In an embodiment, if a partnership won the bid, the present invention may further comprise associating the win with the partnership data (830) and associating the win with each vendor profile capability data (840). In an alternative embodiment, if a partnership lost the bid, the present invention may further comprise associating the loss with the partnership data (850), and associating the loss with each vendor profile capability data (860). Accordingly, vendor profile data for registered vendors submitting a bid may be associated with the success of the bid.

A further embodiment of improving teaming bid success (800) may comprise updating teaming algorithm data (870). Bid success may reflect many factors, such as individual registered vendor capability, strengths of individual registered vendors on a team, or strengths as a team. In an exemplary embodiment, weighted values may be assigned to registered vendor capability data based on bid success, such as assigning a lower weight to vendor capability data associated with a loss and higher weight to vendor capability associated with a win. In an alternative embodiment, weighted values may be assigned to vendors on a successful bid team, such as associating higher weights to vendors on prime-subcontractor teams associated with a win and associating lower weights to vendors on prime-subcontractor teams associated with a loss. In a further alternative embodiment, weights may be assigned to vendors on a vendor team based on frequency of success with other vendors, such as associating a higher weight to vendor combinations that frequently win bids, and associating a lower weight to vendor combinations that frequently lose bids. Accordingly, teaming algorithm data may remain robust with feedback from teaming bid success.

After associating a successful win with each vendor capability profile (840) or associating a loss with each vendor capability profile (860), and updating teaming algorithm data (870), an embodiment of the present invention may further comprise storing associated vendor capability data and updated teaming algorithm data (880). Accordingly, the present invention may respond to bid success data.

As described herein above in various exemplary embodiments of the present disclosure, prime and subcontractor teaming system and methods may comprise collecting vendor profile data, collecting solicitation document data, creating a common framework for comparing vendor profile data to solicitation document data, and analyzing for vendor pairings likely to achieve bid success. Accordingly, as disclosed herein, a common framework may support prime-subcontractor teaming.

It is to be understood that the various embodiments shown and described herein are to be taken as exemplary. Elements and materials, and arrangements of those elements and materials, may be substituted for those illustrated and described herein, parts may be reversed, and certain features of the present disclosure may be utilized independently, as would be apparent to one skilled in the art after having the benefit of the description herein. Changes may be made in the elements described herein without departing from the spirit and scope of the present disclosure and following claims, including their equivalents.

It is to be understood that the particular embodiments set forth herein are non-limiting, and modifications to structure, dimensions, materials, and methodologies may be made without departing from the scope of the present disclosure.

For the purposes of this specification and appended claims, unless otherwise indicated, all numbers expressing quantities, percentages or proportions, and other numerical values used in the specification and claims, are to be understood as being modified in all instance by the term “about” if they are not already. That is, unless indicated to the contrary, the numerical parameters set forth in the specification and claims are approximations that may vary depending on the desired properties sought to be obtained by the present disclosure.

What is claimed is:

1. A system, comprising:
a teaming analyzer, comprising an agency code associating module and at least one analysis module; and
a database in communication with the teaming analyzer;

2. The system of claim 1, wherein the database comprises an agency code associated data table.

3. The system of claim 1, wherein the at least one analysis module is selected from the group consisting of a report card module, an opportunity evaluation analysis module, a preferred vendor analysis module, a suggested vendor analysis module, and combinations thereof.

4. The system of claim 1, wherein the teaming analyzer further comprises a bid module.

5. The system of claim 1, wherein the teaming analyzer further comprises a vendor representative registration module.

6. The system of claim 1, wherein the teaming analyzer further comprises a report generation module.

7. A method, comprising:
identifying an agency code scheme;
associating vendor profile data with the identified scheme; and
associating solicitation document data with the identified scheme;

8. The method of claim 7, wherein the identified scheme comprises a North American Industry Classification System.

9. The method of claim 7, further comprising identifying vendor profile data selected from the group consisting of vendor capability data, vendor prior contract data, vendor performance data, and combinations thereof.

10. The method of claim 7, further comprising identifying solicitation document data selected from the group consisting of evaluation criteria data, solicitation document identifier data, requirements data, and combinations thereof.

11. The method of claim 7, further comprising storing the associated data.

12. The method of claim 7, further comprising identifying errors in the associated data and correcting the identified errors.

13. The method of claim 7, further comprising updating the associated vendor profile data based on bid success.

14. A method, comprising:
comparing agency code associated vendor profile data to agency code associated solicitation document data; and
recommending a vendor pairing based on the comparison.

15. The method of claim 14, further comprising performing competitive position analysis and generating competitive position analysis results.

16. The method of claim 14, further comprising performing preferred vendor teaming analysis and generating preferred vendor teaming analysis results.

17. The method of claim 14, further comprising performing suggested vendor teaming analysis and generating suggested vendor teaming analysis results.

18. The method of claim 14, further comprising registering a vendor.

19. The method of claim 18, further comprising requesting a solicitation document by the registered vendor.

20. The method of claim 18, further comprising requesting a competitive position analysis by the registered vendor.
